(19) United States
(12) Patent Application Publication
(10) Pub. No.: US 2026/0088502 A1
(43) Pub. Date: Mar. 26, 2026

(54) ANTENNA, ANTENNA MODULE, AND ELECTRONIC DEVICE

(71) Applicant: HUAWEI TECHNOLOGIES CO., LTD., Shenzhen (CN)

(72) Inventors: Jie Peng, Shanghai (CN); Huailin Yuan, Xi'an (CN); Wenqi Ding, Shenzhen (CN); Qian Zhou, Shanghai (CN); Laijun Li, Shenzhen (CN); Wentao Cao, Xi'an (CN)

(21) Appl. No.: 19/404,484

(22) Filed: Dec. 1, 2025

Related U.S. Application Data
(63) Continuation of application No. PCT/CN2023/097949, filed on Jun. 2, 2023.

(51) Int. Cl. H01Q 5/25; H01Q 1/42; H01Q 9/04

(52) U.S. Cl. CPC H01Q 5/25; H01Q 1/422; H01Q 9/0407

(57) ABSTRACT

An antenna, antenna module, and electronic device. An antenna includes a first dielectric layer, a second dielectric layer, and a third dielectric layer. The second dielectric layer and the third dielectric layer are disposed on a same side of the first dielectric layer. The second dielectric layer and the third dielectric layer are disposed at different layers. A first radiating element is disposed at the first dielectric layer. A feed line is disposed at the second dielectric layer which feeds the first radiating element. A split resonance unit is disposed at the third dielectric layer, and in signal connection with the feed line. The split resonance unit is disposed on an input port of the antenna. In response to the split resonance unit operating on a resonant frequency thereof, the split resonance unit generates a transmission zero near the resonant frequency of the split resonance unit.

### CROSS-REFERENCE TO RELATED APPLICATIONS

This application is a continuation of International Patent Application No. PCT/CN2023/097949, filed on Jun. 2, 2023, the disclosure of which is hereby incorporated by reference in its entirety.

### TECHNICAL FIELD

This application relates to the field of communication technologies, and in particular, to an antenna, an antenna module, and an electronic device.

### BACKGROUND

To support a higher data communication rate, the international telecommunication union (ITU)-radiocommunication sector lists a millimeter wave frequency band as a 5th generation mobile communication technology (5G) candidate frequency band. A 26 GHz frequency band is a 5G millimeter wave frequency band with highest global attention. For example, a 5G millimeter wave frequency band in China is 24.75 GHz to 27.5 GHZ, and a 5G millimeter wave frequency band in Europe is 24.25 GHz to 27.5 GHz (collectively referred to as a 26 GHz base station).

Currently, the confederation of European posts and telecommunications (CEPT)-electronic communications committee (ECC) organization has stipulated an out-of-band spurious constraint applicable to the 26 GHz base station, to avoid interference of the 26 GHz base station to an earth exploration-satellite service (EESS) and a radio astronomy service (RAS) in an adjacent frequency band (namely, the frequency band is 23.6 GHz to 24 GHZ).

An existing base station may suppress out-of-band spur by using a digital pre-distortion (DPD) technology. That is, a nonlinear unit is added between an input signal and a power amplifier, to add nonlinear distortion to the signal in advance. However, the DPD technology is limited by bandwidth throttling, and is usually for correcting third-order nonlinearity of the power amplifier. If EESS spur is in a fifth-order nonlinear area, a DPD correction bandwidth needs to be greatly broadened, which increases a corresponding digital-to-analog converter (DAC) sampling rate and corresponding DPD algorithm overheads. In addition, a base station system cannot bear increased power consumption. In addition, the existing base station further considers suppressing the spur by adding a filter to an output end of the power amplifier. However, this increases costs of the base station. In addition, for a millimeter-wave base station, layout space of the base station is limited, and the filter cannot be arranged.

### SUMMARY

This application provides an antenna, an antenna module, and an electronic device, so that a split resonance unit is added to an input port of the antenna, to implement a transmission zero outside a passband of the antenna, thereby suppressing out-of-band spur of the antenna.

According to a first aspect, this application provides an antenna. The antenna may include a first dielectric layer, a second dielectric layer, and a third dielectric layer. The second dielectric layer and the third dielectric layer are disposed on a same side of the first dielectric layer, and the second dielectric layer and the third dielectric layer are disposed at different layers. Specifically, a first radiating element is disposed at the first dielectric layer. A feed line is disposed at the second dielectric layer, and the feed line is configured to feed the first radiating element. A split resonance unit is disposed at the third dielectric layer, and the split resonance unit is in signal connection with the feed line.

The split resonance unit is disposed on an input port of the antenna. When the split resonance unit operates on a resonant frequency thereof, the split resonance unit may generate a transmission zero near the resonant frequency of the split resonance unit. A stopband near the transmission zero may suppress a signal. Therefore, during actual application, the antenna in this application may set the resonant frequency of the split resonance unit based on a to-be-suppressed out-of-band spurious frequency band, to implement the transmission zero and form the stopband in the frequency band, thereby suppressing out-of-band spur of the antenna.

In the antenna in this application, a manner in which the feed line is in signal connection with the split resonance unit is not specifically limited. In some technical solutions, the feed line may be in signal connection with the split resonance unit through coupling. Specifically, along a first direction perpendicular to the third dielectric layer, the feed line has a first projection at the third dielectric layer, and the first projection at least partially overlaps the split resonance unit.

In the foregoing technical solution, a size of an area of an overlapping part between the first projection and the split resonance unit is not specifically limited. For example, in some technical solutions, the first projection and the split resonance unit may have one intersection point, namely, a first intersection point.

When the first projection and the split resonance unit have the intersection point, the split resonance unit may be an irregular figure. Certainly, the split resonance unit may alternatively be a symmetric figure. In addition, to improve signal strength of the split resonance unit, a split of the split resonance unit is not symmetric with respect to the first projection.

In some other technical solutions, the first projection and the split resonance unit may alternatively have at least two intersection points; and the at least two intersection points may include a second intersection point that is closest to a split along a circumference of the split resonance unit; and along the circumference of the split resonance unit, there is a first distance between the second intersection point and one end of the split, there is a second distance between the second intersection point and the other end of the split, and the first distance is less than the second distance, so that the split resonance unit has a good resonance function.

In addition to the foregoing coupling manner, the feed line may further be directly connected to the split resonance unit. Specifically, in some technical solutions, along a first direction perpendicular to the third dielectric layer, the feed line has a first projection at the third dielectric layer, and the first projection does not intersect the split resonance unit; and the antenna may further include a transmission line, where the transmission line has two ends, namely, a first end and a second end, the first end is connected to the feed line, and the second end is connected to the split resonance unit. The signal connection is implemented through the transmission line, so that a distance between the split resonance unit and the feed line can be set based on a specific application scenario, to flexibly set a position of the split resonance unit.

When a specific structure of the antenna is set, the transmission line has a second projection at the third dielectric layer along the first direction. To implement impedance matching between the feed line and the first radiating element, a length L1 of the second projection may satisfy (2n+1)λ/4−λ/8≤L1≤(2n+1)λ/4+λ/8, where n is a natural number, and λ is a dielectric wavelength of the third dielectric layer.

When the length L1 of the second projection is (2n+1)λ/4, impedance matching between the feed line and the split resonance unit is optimal, and energy efficiency is the highest.

In the antenna in this application, a manner in which the feed line feeds the first radiating element is not specifically limited either. In some technical solutions, the feed line may feed the first radiating element through slot feeding. Specifically, the antenna may further include a fourth dielectric layer located between the first dielectric layer and the second dielectric layer, where a slot is provided at the fourth dielectric layer, and the feed line feeds the first radiating element through the slot.

In the foregoing antenna, the slot has a third projection at the third dielectric layer along the first direction, and the third projection may intersect the first projection at a third intersection point. There is a first spacing D1 between the first intersection point, the second intersection point, or the first end of the transmission line and the third intersection point. To implement the impedance matching between the feed line and the first radiating element, the first spacing D1 may satisfy (2n+1)λ/4−λ/8≤D1≤(2n+1)λ/4+λ/8, where n is a natural number, and λ is the dielectric wavelength of the third dielectric layer.

When the first spacing D1 is (2n+1)λ/4, the impedance matching between the feed line and the first radiating element is optimal, and the energy efficiency is the highest.

In addition to the foregoing slot feeding manner, the feed line may further be directly connected to the first radiating element, and feed the first radiating element. Specifically, in some technical solutions, the antenna may further include a probe component, one end of the probe component is connected to the feed line, and the other end is connected to the first radiating element, so that the feed line directly feeds the first radiating element by using the probe component.

In the foregoing antenna, the probe component has a fourth projection at the third dielectric layer along the first direction, and the fourth projection intersects the first projection at a fourth intersection point. There is a second spacing D2 between the first intersection point, the second intersection point, or the first end and the fourth intersection point. To implement impedance matching between the feed line and the first radiating element, the second spacing D2 satisfies (2n+1)λ/4−λ/8≤D2≤(2n+1)λ/4+λ/8, where n is a natural number, and λ is the dielectric wavelength of the third dielectric layer.

When the second spacing D2 is (2n+1)λ/4, the impedance matching between the feed line and the first radiating element is optimal, and the energy efficiency is the highest.

In the antenna in this application, the split resonance unit may include at least one split resonator. For example, a quantity of split resonators may be one, two, three, or four. A specific quantity is not limited.

In addition, a circumference of each split resonator is an integer multiple of ½ of the dielectric wavelength of the third dielectric layer, to achieve a good resonance effect.

In some technical solutions, the split resonance unit may include a first split resonator and a second split resonator, and the first split resonator and the second split resonator may be separately in signal connection with the feed line; along the first direction perpendicular to the third dielectric layer, the feed line has the first projection at the third dielectric layer; and the first split resonator and the second split resonator may be symmetrically disposed with respect to the first projection; or the first split resonator and the second split resonator may be disposed at an interval along a direction of the feed line. Certainly, the second split resonator may alternatively be coupled to the first split resonator. For example, in some technical solutions, the split resonance unit includes a first split resonator and a second split resonator that are spaced, the first split resonator and the second split resonator are symmetrically disposed with respect to a centrosymmetric line, a split of the first split resonator and a split of the second split resonator are oriented in a same direction, and the first split resonator is disposed close to the feed line, and is in signal connection with the feed line.

In the antenna in this application, a specific shape of the split resonator is not limited. For example, the split resonator may be a triangular split resonator, a circular split resonator, a rhombic split resonator, a rectangular split resonator, or an 8-shaped split resonator. This is not enumerated herein.

In addition, the split resonator may be specifically a defected-ground split resonator; or the split resonator may be a metal split resonator.

In addition, in the antenna in this application, a specific quantity of radiating elements is not limited. For example, in some technical solutions, the antenna may further include a fifth dielectric layer located on a side that is of the first dielectric layer and that is away from the second dielectric layer, a second radiating element may be disposed at the fifth dielectric layer, and the second radiating element is in signal connection with the first radiating element.

During setting of the feed line, a specific type of the feed line is not limited. For example, the feed line may include a strip line, a micro strip, or a coaxial line.

According to a second aspect, this application further provides an antenna module. The antenna module includes a plurality of antennas in the first aspect. In the foregoing antenna module, a split resonance unit is disposed at an input port of each antenna. When the split resonance unit operates on a resonant frequency thereof, the split resonance unit may generate a transmission zero near the resonant frequency of the split resonance unit. A stopband near the transmission zero may suppress a signal. Therefore, during actual application, the antenna module in this application may set the resonant frequency of the split resonance unit of the antenna based on a to-be-suppressed out-of-band spurious frequency band, to implement the transmission zero and form the stopband in the frequency band, thereby suppressing out-of-band spur of the antenna module.

In some technical solutions, the antenna module may further be used in a phased array. Specifically, the antenna module may further include a feed transmission line and a radio frequency integrated circuit (RFIC). When the radio frequency integrated circuit and the antennas are specifically disposed, an antenna-in-package (AIP) technology may be used. Specifically, the antenna module may further include a first substrate and a second substrate; the radio frequency integrated circuit may be disposed on a side of the first substrate, the second substrate is disposed on a a side that is of the radio frequency integrated circuit and that is away from the first substrate, and the feed transmission line is disposed on the second substrate; and the plurality of antennas may be disposed on a side that is of the second substrate and that is away from the radio frequency integrated circuit, and be connected to the radio frequency integrated circuit through the feed transmission line.

Alternatively, the antenna module may use an antenna-on-chip (AOC) technology. Specifically, the antenna module may further include a first substrate; the radio frequency integrated circuit may be disposed on a side of the first substrate, and the feed transmission line is disposed on the radio frequency integrated circuit; and the plurality of antennas may be disposed on a side that is of the radio frequency integrated circuit and that is away from the first substrate, and be connected to the radio frequency integrated circuit through the feed transmission line.

Alternatively, the antenna module may use an antenna-on-board (AOB) technology. Specifically, the antenna module may further include a circuit board; the feed transmission line is disposed on the circuit board, and the radio frequency integrated circuit may be disposed on a side of the circuit board; and the plurality of antennas may be disposed on a side that is of the circuit board and that is away from the radio frequency integrated circuit, and be connected to the radio frequency integrated circuit through the feed transmission line.

According to a third aspect, this application further provides an electronic device. The electronic device includes the antenna module in the second aspect. In the foregoing electronic device, the antenna module may have a stopband outside a passband, so that out-of-band spur of the electronic device can be suppressed.

### BRIEF DESCRIPTION OF DRAWINGS

FIG. 1 is a diagram of a structure of an antenna according to an embodiment of this application;

FIG. 2 is a diagram of another structure of the antenna in FIG. 1;

FIG. 3 is a diagram of another structure of an antenna according to an embodiment of this application;

FIG. 4 is a diagram of another structure of the antenna in FIG. 3;

FIG. 5 is a diagram of projections of a feed line and a slot in FIG. 3 at a third dielectric layer along a first direction;

FIG. 6 is a diagram of a structure of a split resonance unit according to an embodiment of this application;

FIG. 7(a) to FIG. 7(d) show other projections of a feed line and a slot of an antenna at a third dielectric layer along a first direction according to an embodiment of this application;

FIG. 8(a) to FIG. 8(c) show other projections of a feed line and a slot of an antenna at a third dielectric layer along a first direction according to an embodiment of this application;

FIG. 9 shows an equivalent topology structure of the antenna in FIG. 3;

FIG. 10 shows a curve in which a gain of the antenna in FIG. 7(a) to FIG. 7(d) varies with a frequency;

FIG. 11 is a diagram of other projections of a feed line and a slot at a third dielectric layer along a first direction according to an embodiment of this application;

FIG. 12 is a diagram of projections of a first radiating element, a feed line, and a slot at a third dielectric layer along a first direction according to an embodiment of this application;

FIG. 13 is a diagram of other projections of a first radiating element, a feed line, and a slot at a third dielectric layer along a first direction according to an embodiment of this application;

FIG. 14 is a diagram of other projections of a first radiating element, a feed line, and a slot at a third dielectric layer along a first direction according to an embodiment of this application;

FIG. 15 is a diagram of other projections of a first radiating element, a feed line, and a slot at a third dielectric layer along a first direction according to an embodiment of this application;

FIG. 16 is a diagram of other projections of a first radiating element, a feed line, and a slot at a third dielectric layer along a first direction according to an embodiment of this application;

FIG. 17 is a diagram of other projections of a first radiating element, a feed line, and a slot at a third dielectric layer along a first direction according to an embodiment of this application;

FIG. 18 is a diagram of a structure of an antenna module according to an embodiment of this application;

FIG. 19 is a diagram of another structure of an antenna module according to an embodiment of this application;

FIG. 20 is a diagram of another structure of an antenna module according to an embodiment of this application; and

FIG. 21 is a diagram of another structure of an antenna module according to an embodiment of this application.

### REFERENCE NUMERALS

10: Antenna;
11: First dielectric layer;
12: Second dielectric layer;
13: Third dielectric layer;
14: Fourth dielectric layer;
15: Fifth dielectric layer;
20: Antenna module;
21: First substrate;
22: Feed transmission line;
23: Second substrate;
24: Ball grid array;
25: Circuit board;
111: First radiating element;
121: Feed line;
131: Split resonance unit;
131a: First split resonator;
131b: Second split resonator;
141: Slot;
151: Second radiating element;
S1: First projection;
S2: Second projection;
S3: Third projection;
S4: Fourth projection; and
S5: Fifth projection.

### DESCRIPTION OF EMBODIMENTS

To make the objectives, technical solutions, and advantages of this application clearer, the following further describes this application in detail with reference to the accompanying drawings

Reference to “an embodiment”, “some embodiments”, or the like described in this specification means that one or more embodiments of this application include a specific feature, structure, or characteristic described with reference to embodiments. Therefore, statements such as “in an embodiment”, “in another embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specially emphasized in another manner. The terms “include”, “contain”, “have”, and their variants all mean “include but are not limited to”, unless otherwise specially emphasized in another manner.

Terms used in the following embodiments are merely intended to describe specific embodiments, but are not intended to limit this application. The singular expression forms “one”, “a”, “the”, “the foregoing”, “this”, and “the one” used in the specification and the appended claims of this application are intended to also include expression forms such as “one or more”, unless explicitly indicated to the contrary in the context.

This application provides an antenna, an antenna module, and an electronic device, so that a split resonance unit is added to an input port of the antenna, to implement a transmission zero outside a passband of the antenna, thereby suppressing out-of-band spur of the antenna.

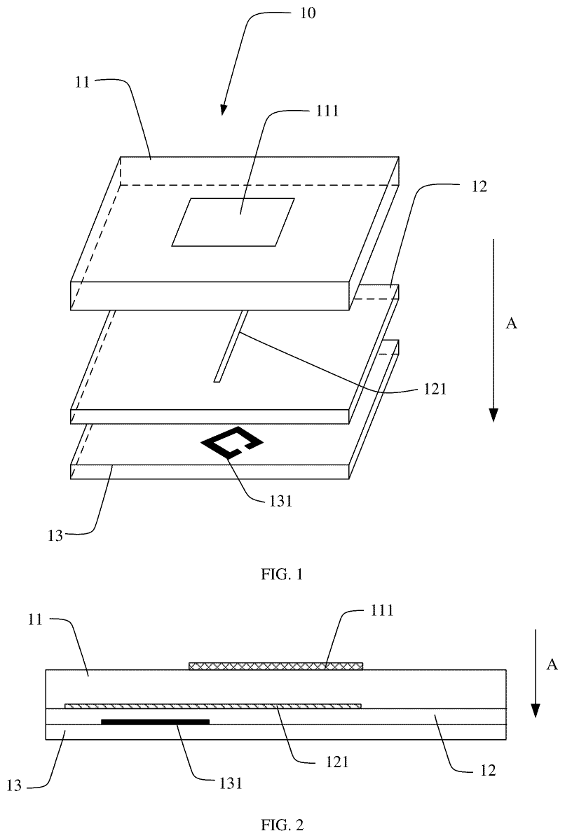

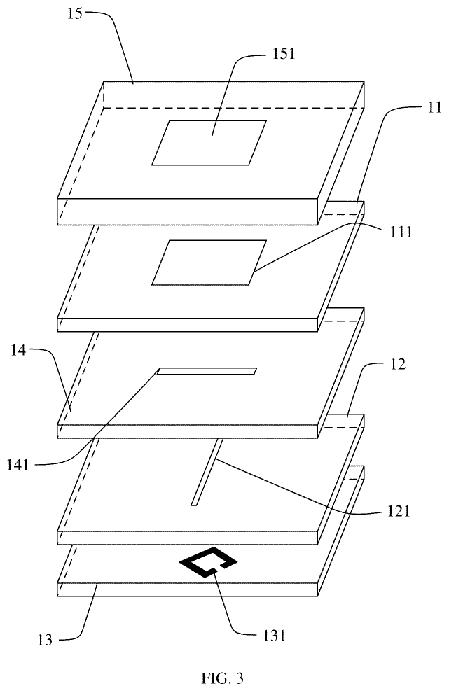

FIG. 1 is a diagram of a structure of an antenna according to an embodiment of this application. FIG. 2 is a diagram of another structure of the antenna in FIG. 1. As shown in FIG. 1 and FIG. 2, the antenna 10 may include a first dielectric layer 11, a second dielectric layer 12, and a third dielectric layer 13. Along a first direction A perpendicular to the third dielectric layer 13, the second dielectric layer 12 and the third dielectric layer 13 are located on a same side of the first dielectric layer 11, and the second dielectric layer 12 and the third dielectric layer 13 are disposed at different layers. Specifically, a first radiating element 111 is disposed at the first dielectric layer 11. A feed line 121 is disposed at the second dielectric layer 12, and the feed line 121 is configured to feed the first radiating element 111. A split resonance unit 131 is disposed at the third dielectric layer 13, and the split resonance unit 131 is in signal connection with the feed line 121. In the antenna 10 having the foregoing structure, the split resonance unit 131 is disposed at an input port of the antenna 10. When the split resonance unit 131 operates on a resonant frequency thereof, the split resonance unit 131 may generate a transmission zero near the resonant frequency of the split resonance unit 131. A stopband near the transmission zero may suppress a signal. Therefore, during actual application, the antenna 10 in this application may set the resonant frequency of the split resonance unit 131 based on a to-be-suppressed out-of-band spurious frequency band, to implement the transmission zero and form the stopband in the frequency band, thereby suppressing out-of-band spur of the antenna 10.

In embodiments of this application, the first dielectric layer 11, the second dielectric layer 12, and the third dielectric layer 13 are for signal transmission, and may use a same dielectric material, or may use different dielectric materials. Herein, the dielectric material may be air or a dielectric material other than the air. For example, in some embodiments, the first dielectric layer 11 and the third dielectric layer 13 may be air, and the second dielectric layer 12 may be a dielectric substrate. In these embodiments, one end of the first radiating element 111 may be mounted on the dielectric substrate and disposed in a suspended manner, and one end of the split resonance unit 131 may be mounted on the dielectric substrate and disposed in the suspended manner. In some other embodiments, the first dielectric layer 11, the second dielectric layer 12, and the third dielectric layer 13 may alternatively be dielectric supports of a same material. In these embodiments, the dielectric support may be constructed in different shapes. For example, the dielectric support may be in a plate shape, a column shape, a rod shape, or another irregular shape. In this case, a surface layer that is on the dielectric support and that carries another component (for example, the first radiating element 111, the feed line 121, or the split resonance unit 131) of the antenna 10 may be simplified into a dielectric layer.

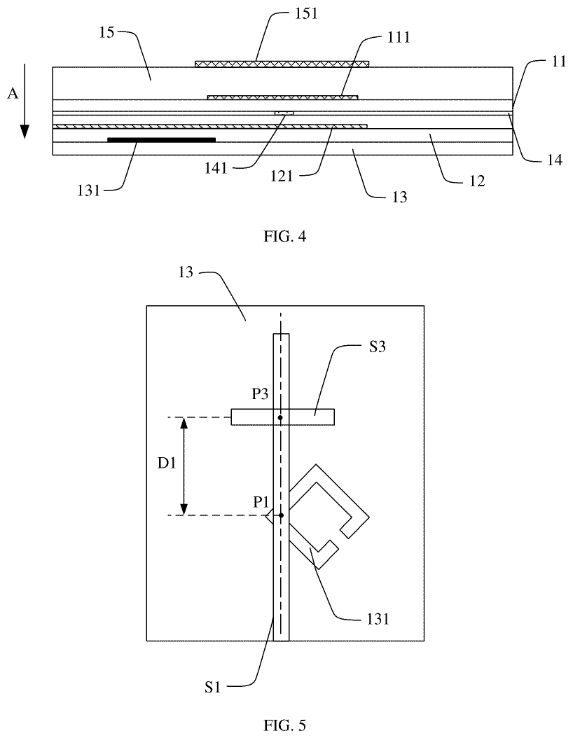

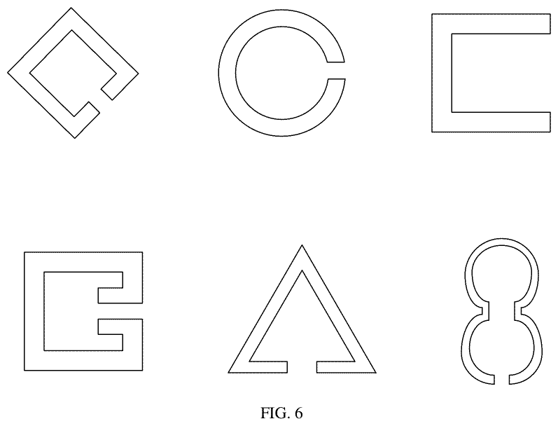

Specifically, in the antenna 10 in this application, the feed line 121 is signal connection with the split resonance unit 131. A connection manner is not specifically limited. For example, in some embodiments, the feed line 121 may be signal connection with the split resonance unit 131 through coupling. FIG. 3 is a diagram of another structure of an antenna according to an embodiment of this application. FIG. 4 is a diagram of another structure of the antenna in FIG. 3. FIG. 5 is a diagram of projections of a feed line and a slot in FIG. 3 at a third dielectric layer along a first direction. As shown in FIG. 3, FIG. 4, and FIG. 5, along the first direction A, the feed line 121 has the first projection S1 at the third dielectric layer 13, and the first projection S1 at least partially overlaps a split resonance unit 131.

It should be noted that, in the antenna 10 in this application, the split resonance unit 131 may include at least one split resonator. For example, a quantity of split resonators may be one, two, three, or four. A specific quantity is not limited. In addition, a specific shape of the split resonator is not limited. FIG. 6 is a diagram of a structure of a split resonance unit according to an embodiment of this application. As shown in FIG. 6, in some embodiments, a split resonator may be a symmetric figure. For example, the split resonator may be triangular, circular, rhombic, rectangular, or 8-shaped. Certainly, in some other embodiments, a split resonator may alternatively be an irregular figure.

In the foregoing embodiments, a size of an area of an overlapping part between the first projection S1 and the split resonance unit 131 is not specifically limited. For example, in some embodiments, the first projection S1 and the split resonance unit 131 may have a first intersection point. Alternatively, in some other embodiments, the first projection S1 and the split resonance unit 131 may have at least two intersection points.

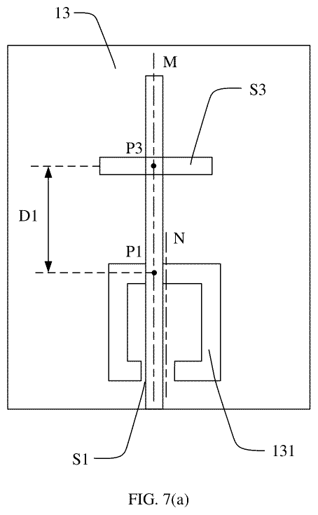

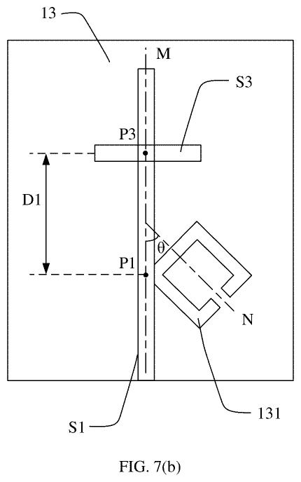

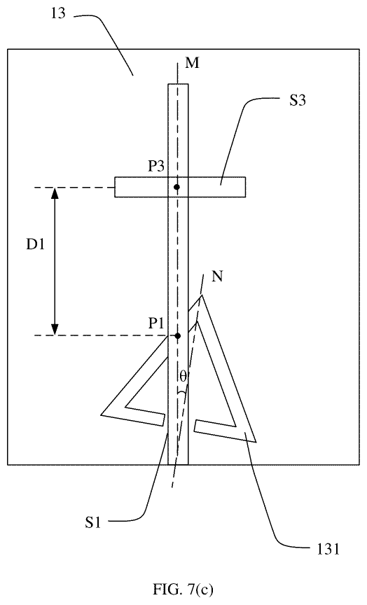

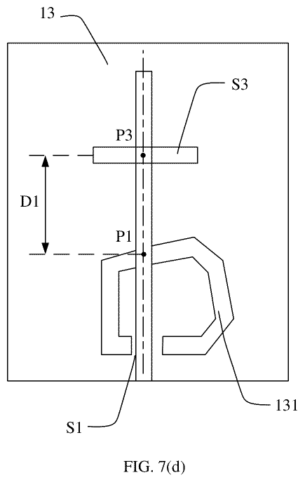

FIG. 7(a) to FIG. 7(d) show other projections of a feed line and a slot of an antenna at a third dielectric layer 13 along a first direction according to an embodiment of this application. As shown in FIG. 7(a) to FIG. 7(d), when the first projection S1 and a split resonance unit 131 have a first intersection point P1, the split resonance unit 131 may be symmetric figures shown in FIG. 7(a) to FIG. 7(c), or may be an asymmetric figure shown in FIG. 7(d). When the split resonance unit 131 is a symmetric figure, a split of the split resonance unit 131 is not symmetric with respect to the first projection S1, to avoid that the split resonance unit 131 is axisymmetric with respect to the first projection S1, thereby improving signal strength of the split resonance unit 131. Certainly, the split resonance unit 131 may further be as close as possible to the feed line 121, so that a size of the antenna 10 in this direction can be reduced while the signal strength of the split resonance unit 131 is improved, to implement miniaturization of the antenna 10.

In the foregoing embodiment, the split resonance unit 131 may be disposed at an included angle with the first projection S1, so that a magnitude of the included angle can be adjusted based on an out-of-band suppression requirement of the antenna 10, to adjust signal coupling strength between the feed line 121 and the split resonance unit 131. A specific magnitude of the foregoing included angle is not limited, for example, may be set to be greater than or equal to 0 degrees and less than or equal to 90 degrees. The split resonance unit 131 which is an axisymmetric figure is used as an example. As shown in FIG. 7(a) to FIG. 7(c), the first projection S1 of the feed line 121 has a center line M, and the split resonance unit 131 has a symmetric center line N. An included angle θ between the center line M and the symmetric center line N is the included angle between the split resonance unit 131 and the first projection S1. As shown in FIG. 7(a), when the center line M is parallel to the symmetric center line N, the included angle may be 0 degrees. As shown in FIG. 7(b), when the included angle is 45 degrees, the signal coupling strength between the feed line 121 and the split resonance unit 131 is optimal. Certainly, as shown in FIG. 7(c), the angle may alternatively be another degree. Details are not described one by one herein again.

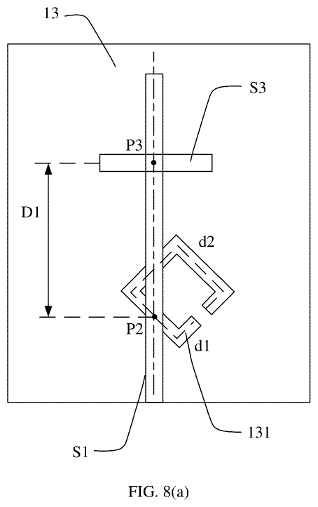

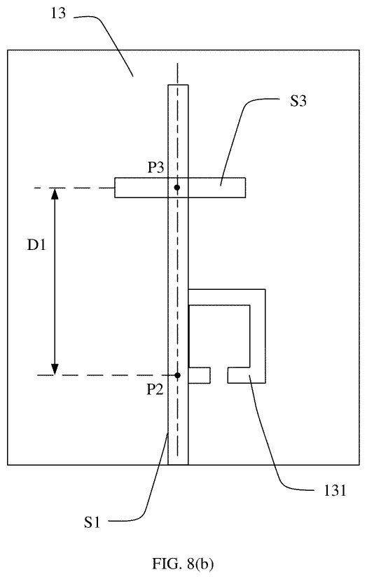

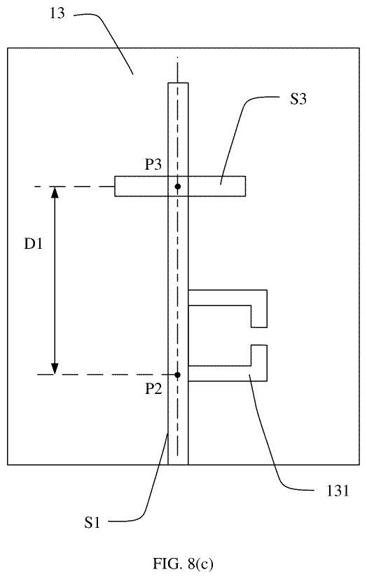

FIG. 8(a) to FIG. 8(c) show other projections of a feed line and a slot of an antenna at a third dielectric layer 13 along a first direction according to an embodiment of this application. As shown in FIG. 8(a) to FIG. 8(c), in some other embodiments, the first projection S1 and a split resonance unit 131 may alternatively have at least two intersection points. For example, as shown in FIG. 8(a), the first projection S1 and the split resonance unit 131 may have two intersection points. Alternatively, as shown in FIG. 8(b) and FIG. 8(c), the first projection S1 overlaps a part of the split resonance unit 131. In other words, the first projection S1 and the split resonance unit 131 may have countless intersection points. The at least two intersection points may include a second intersection point P2 that is closest to a split along a circumference of the split resonance unit 131; and along the circumference of the split resonance unit 131, there is a first distance d1 between the second intersection point P2 and one end of the split, there is a second distance d2 between the second intersection point P2 and the other end of the split, and the first distance dl is less than the second distance d2, so that the split resonance unit 131 has a good resonance function.

To achieve a good resonance effect, a circumference of each split resonator in the split resonance unit 131 may be an integer multiple of ½ of a dielectric wavelength of the third dielectric layer 13. In addition, the split resonator may be a defected-ground split resonator. Specifically, a metal layer is disposed at the third dielectric layer 13, and etching is performed at the metal layer by using an etching process, to form the split resonator. Alternatively, the split resonator may be a metal split resonator. Specifically, a metal material is made into the split resonator, and the split resonator is fastened at the third dielectric layer 13, to reduce manufacturing costs.

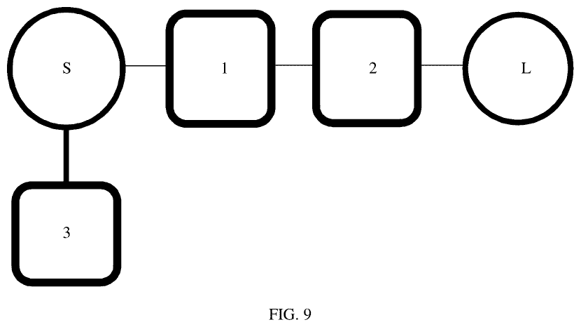

A passband of the antenna 10 is mainly determined by a radiating element. In the antenna 10 in this application, a specific quantity of radiating elements is not limited. For example, as shown in FIG. 1 and FIG. 2, in some embodiments, the antenna 10 includes the first radiating element 111. In this case, the passband of the antenna 10 is determined by the first radiating element 111. As shown in FIG. 3 and FIG. 4, in some other embodiments, the antenna 10 may further include a fifth dielectric layer 15, and the fifth dielectric layer 15 is located on a side that is of the first dielectric layer 11 and that is away from the second dielectric layer 12. A second radiating element 151 may be disposed at the fifth dielectric layer 15, and the second radiating element 151 may be in signal connection with a first radiating element 111 through coupling. In this case, the passband of the antenna 10 is determined by the first radiating element 111 and the second radiating element 151. FIG. 9 shows an equivalent topology structure of the antenna in FIG. 3. As shown in FIG. 9, the antenna 10 may include the first radiating element 111 and the second radiating element 151. The first radiating element 111 may be equivalent to a filter resonator 1, the second radiating element 151 may be equivalent to a filter resonator 2, and the split resonance unit 131 may be equivalent to a filter resonator 3. The split resonance unit 131 is a non-radiating resonator. In other words, the split resonance unit 131 does not radiate power toward free space. The split resonance unit 131 is a symmetric figure, a center line of the split resonance unit 131 may intersect a center line of the first projection S1 of the feed line 121, an intersection point may be equivalent to a filter input port S, and radiation-free space of the first radiating element 111 may be equivalent to a filter output port L. In a filter topology structure, one transmission zero may be generated near a resonant frequency of the filter resonator 3. A frequency corresponding to the transmission zero depends on the resonant frequency of the resonator 3, that is, may be a frequency below an operating frequency band of the antenna 10, or may be a frequency above the operating frequency band of the antenna 10. Therefore, the antenna 10 may achieve a suppression effect equivalent to that of a third-order filter with a single transmission zero.

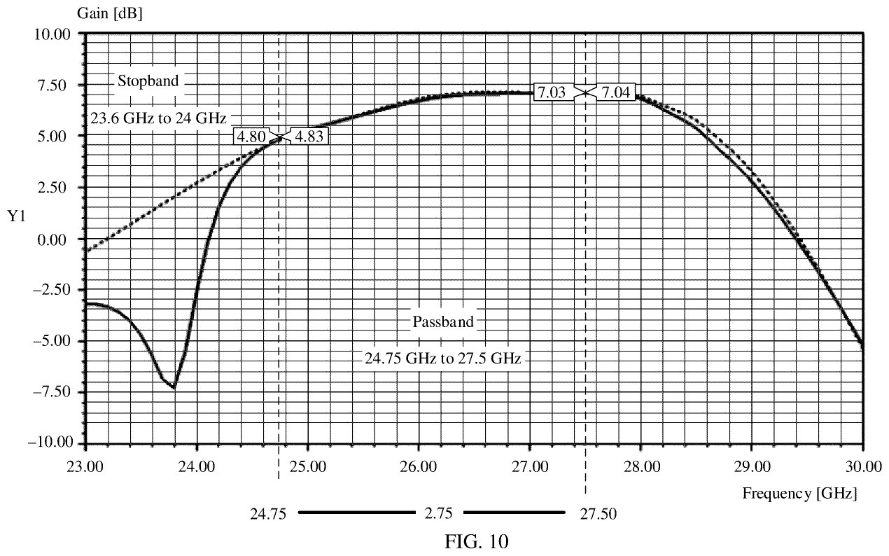

FIG. 10 shows a curve in which a gain of the antenna in FIG. 7(a) to FIG. 7(d) varies with a frequency. As shown in FIG. 10, a solid line represents the antenna 10 in FIG. 7(a) to FIG. 7(d), and an operating frequency band of the antenna 10 is 24.75 GHz to 27.5 GHz. A dashed line is a comparison antenna that does not include the split resonance unit 131. It can be learned that the antenna 10 in this application implements radiation performance equivalent to that of the comparison antenna, and has no distinct gain reduction. In a stopband frequency band 23.6 GHz to 24 GHz of the antenna 10, the gain of the antenna 10 in this application is distinctly lower than that of the comparison antenna, and a strong out-of-band suppression characteristic similar to that of a filter is presented. In addition, near a frequency 23.8 GHz, the antenna 10 in this application has a distinct radiation null.

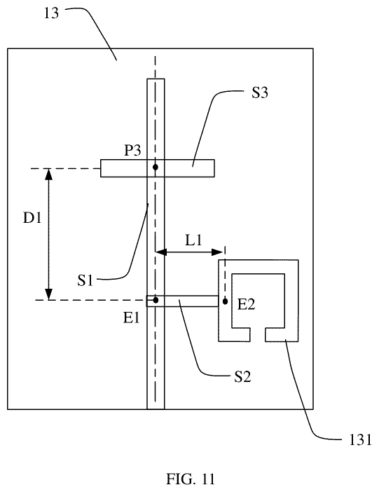

In embodiments of this application, in addition to implementing the signal connection through coupling shown in FIG. 1 and FIG. 3, the feed line 121 may further be directly connected to the split resonance unit 131. FIG. 11 is a diagram of other projections of a feed line and a slot at a third dielectric layer along a first direction according to an embodiment of this application. Specifically, in some embodiments, along the first direction A, the feed line 121 has the first projection S1 at the third dielectric layer 13, and the first projection S1 does not intersect a split resonance unit 131. An antenna 10 may further include a transmission line, the transmission line has two ends, namely, a first end E1 and a second end E2, the first end E1 is connected to the feed line 121, and the second end E2 is connected to the split resonance unit 131. The signal connection is implemented through the transmission line, so that a distance between the split resonance unit 131 and the feed line 121 can be set based on a specific application scenario, to flexibly set a position of the split resonance unit 131.

As shown in FIG. 11, when a specific structure of the antenna 10 is set, the transmission line has a second projection S2 at the third dielectric layer 13 along the first direction. To implement impedance matching between the feed line 121 and a first radiating element 111, a length L1 of the second projection S2 may satisfy (2n+1)λ/4−λ/8≤L1≤(2n+1)λ/4+λ/8, where n is a natural number, and λ is a dielectric wavelength of the third dielectric layer 13. When the length L1 of the second projection S2 is (2n+1)λ/4, impedance matching between the feed line 121 and the split resonance unit 131 is optimal, and energy efficiency is the highest.

In the antenna 10 in this application, a manner in which the feed line 121 feeds the first radiating element 111 is not specifically limited either. In some embodiments, the feed line 121 may feed the first radiating element 111 through the slot 141. Specifically, the antenna 10 may further include a fourth dielectric layer 14 located between a first dielectric layer 11 and a second dielectric layer 12, where the slot 141 is provided at the fourth dielectric layer 14, and the feed line 121 feeds the first radiating element 111 through the slot 141.

As shown in FIG. 5 and FIG. 7(a) to FIG. 7(d), the slot 141 may have the third projection S3 at the third dielectric layer 13 along the first direction A, and the third projection S3 may intersect the first projection S1 at a third intersection point P3. There is a first spacing D1 between the third intersection point P3 and the first intersection point P1. Similarly, in the embodiment in which the split resonance unit 131 is arranged based on FIG. 8(a) to FIG. 8(c), there may also be a second spacing D2 between the third intersection point P3 and the second intersection point P2. Alternatively, in the embodiment in which the split resonance unit 131 is arranged based on FIG. 11, there is a first spacing D1 between the third intersection point P3 and the first end E1. To implement impedance matching between the feed line 121 and a first radiating element 111, the first spacing D1 may satisfy (2n+1)λ/4−λ/8≤D1≤(2n+1)λ/4+λ/8, where n is a natural number, and λ is a dielectric wavelength of the third dielectric layer 13. When the first spacing D1 is (2n+1)λ/4, the impedance matching between the feed line 121 and the first radiating element 111 is optimal, and energy efficiency is the highest. Therefore, the antenna 10 may implement a good out-of-band suppression effect by controlling coupling between the split resonance unit 131 and the feed line 121 and a distance between the split resonance unit 131 and the slot 141, and a transmission loss, system power consumption, and manufacturing costs are all low.

In addition to the foregoing slot feeding manner, the feed line 121 may further be directly connected to the first radiating element 111, and feed the first radiating element 111. Specifically, in some embodiments, the antenna 10 may further include a probe component, one end of the probe component is connected to the feed line 121, and the other end is connected to the first radiating element 111, so that the feed line 121 directly feeds the first radiating element 111 by using the probe component.

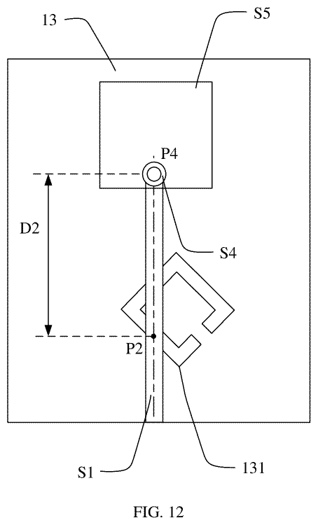

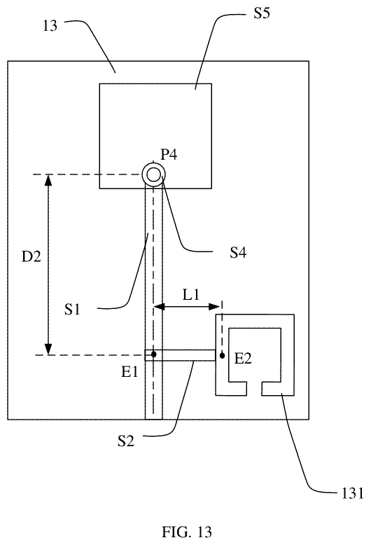

FIG. 12 is a diagram of other projections of a first radiating element, a feed line, and a slot at a third dielectric layer along a first direction according to an embodiment of this application. FIG. 13 is a diagram of other projections of a first radiating element, a feed line, and a slot at a third dielectric layer 13 along a first direction according to an embodiment of this application. As shown in FIG. 12 and FIG. 13, in the foregoing antenna 10, a probe component may have a fourth projection S4 at the third dielectric layer 13 along the first direction A, and the fourth projection S4 intersects the first projection S1 at a fourth intersection point P4. The first radiating element 111 may have the fifth projection S5 at the third dielectric layer 13 along the first direction A. There is a second spacing D2 between the fourth intersection point P4 and a second intersection point P2. Similarly, in the embodiment in which the split resonance unit 131 is arranged based on FIG. 7(a) to FIG. 7(d), there may also be a second spacing D2 between the fourth intersection point P4 and the first intersection point P1; or in the embodiment in which the split resonance unit 131 is arranged based on FIG. 11, there may also be a second spacing D2 between the fourth intersection point P4 and the first end E1. To implement impedance matching between the feed line 121 and the first radiating element 111, the second spacing D2 satisfies (2n+1)λ/4−λ/8≤D2≤(2n+1)λ/4+λ/8, where n is a natural number, and λ is a dielectric wavelength of the third dielectric layer 13. When the second spacing D2 is (2n+1)λ/4, the impedance matching between the feed line 121 and the first radiating element 111 is optimal, and energy efficiency is the highest.

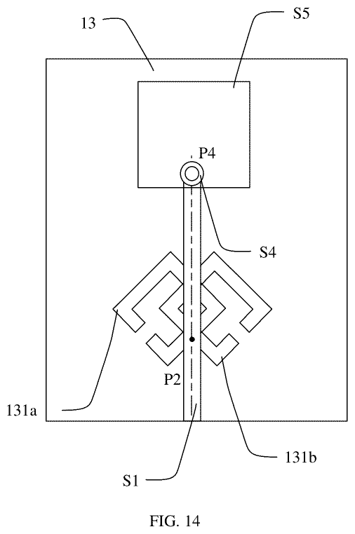

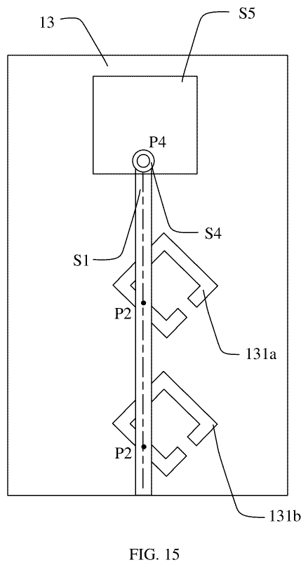

The following provides descriptions by using the split resonance unit 131 which is a symmetric figure as an example. FIG. 14 is a diagram of other projections of a first radiating element, a feed line, and a slot at a third dielectric layer along a first direction according to an embodiment of this application. As shown in FIG. 14, in some embodiments of this application, a split resonance unit 131 may include a first split resonator 131a and a second split resonator 131b, and the first split resonator 131a and the second split resonator 131b may be separately in signal connection with the feed line 121. Along the first direction A, the first split resonator 131a and the second split resonator 131b may be symmetrically disposed with respect to the first projection S1. FIG. 15 is a diagram of other projections of a first radiating element, a feed line, and a slot at a third dielectric layer along a first direction according to an embodiment of this application. As shown in FIG. 15, in some other embodiments, a first split resonator 131a and a second split resonator 131b may alternatively be disposed at an interval along a direction of the feed line 121.

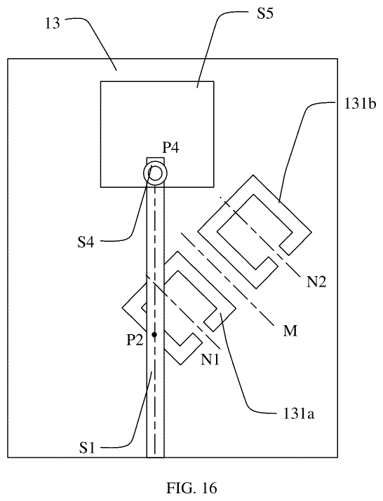

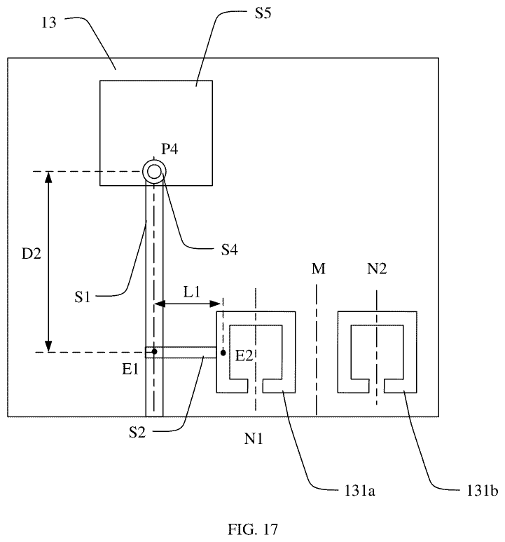

In addition, the second split resonator 131b may alternatively be coupled to the first split resonator 131a. FIG. 16 is a diagram of other projections of a first radiating element, a feed line, and a slot at a third dielectric layer along a first direction according to an embodiment of this application. FIG. 17 is a diagram of other projections of a first radiating element, a feed line, and a slot at a third dielectric layer along a first direction according to an embodiment of this application. As shown in FIG. 16 and FIG. 17, in some other embodiments, a split resonance unit 131 includes a first split resonator 131a and a second split resonator 131b that are spaced, the first split resonator 131a and the second split resonator 131b are symmetrically disposed with respect to a centrosymmetric line M, a split of the first split resonator 131a and a split of the second split resonator 131b are oriented in a same direction, and the first split resonator 131a is disposed close to the feed line 121, and is in signal connection with the feed line 121. When the first split resonator 131a and the second split resonator 131b are symmetric figures, the centrosymmetric line M is parallel to a center line N1 of the first split resonator 131a and a center line N2 of the second split resonator 131b.

In addition, during setting of the feed line 121, a specific type of the feed line 121 is not limited. For example, the feed line 121 may include a strip line, a micro strip, or a coaxial line. This is not enumerated herein again. In addition, the antenna 10 in this application may alternatively be a polarized antenna, for example, may be a vertical single-polarized antenna, a horizontally polarized antenna, a ±45°polarized antenna, a circularly polarized antenna, or a dual-polarized antenna. This is not enumerated herein.

Based on a same design concept, this application further provides an antenna module. The antenna module includes a plurality of antennas 10 in the foregoing embodiments. In the foregoing antenna module, a split resonance unit 131 is disposed at an input port of each antenna 10. When the split resonance unit 131 operates on a resonant frequency thereof, the split resonance unit 131 may generate a transmission zero near the resonant frequency of the split resonance unit 131. A stopband near the transmission zero may suppress a signal. Therefore, during actual application, the antenna module in this application may set the resonant frequency of the split resonance unit 131 of the antenna 10 based on a to-be-suppressed out-of-band spurious frequency band, to implement the transmission zero and form the stopband in the frequency band, thereby suppressing out-of-band spur of the antenna module.

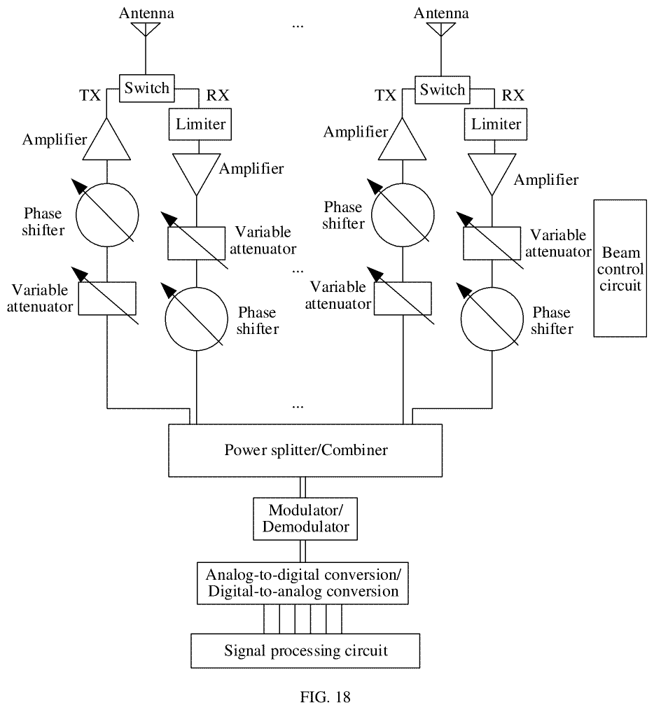

In some embodiments, the antenna module may further be used in a phased array. Specifically, the antenna module may further include a feed transmission line 22 and a radio frequency integrated circuit. FIG. 18 is a diagram of a structure of an antenna module according to an embodiment of this application. As shown in FIG. 18, during actual application, the antenna module 20 may further include a switch, a phase shifter, an attenuator, a frequency mixer, a phase-locked loop, an amplifier, a power splitter, a digital-to-analog converter, a digital signal processing circuit, or the like. A physical implementation form of the antenna module 20 may mainly use an antenna-in-package technology, an antenna-on-chip technology, or an antenna-on-board technology.

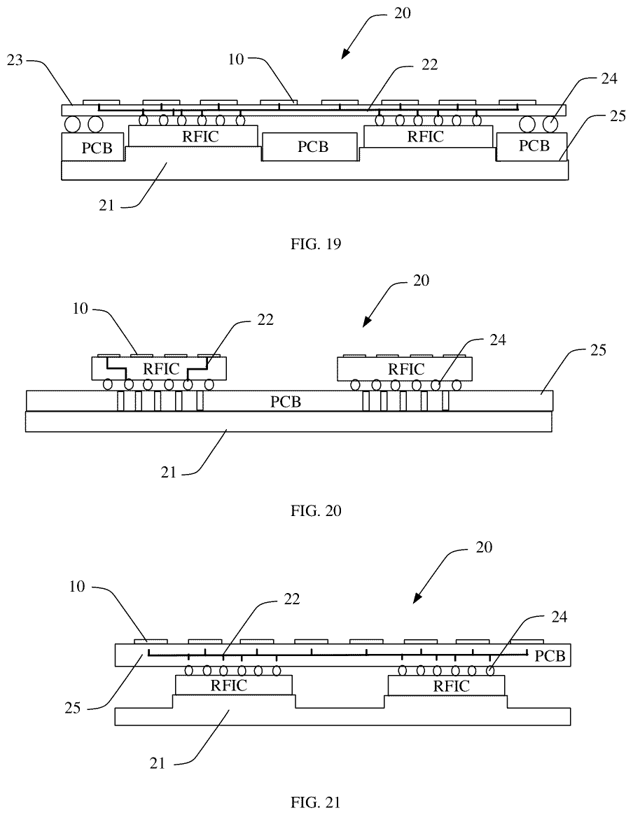

When the radio frequency integrated circuit and the antennas 10 are specifically disposed, an antenna-in-package technology may be used. FIG. 19 is a diagram of a structure of an antenna module according to an embodiment of this application. As shown in FIG. 19, the antenna module 20 may further include a first substrate 21 and a second substrate 23; the radio frequency integrated circuit may be disposed on a side of the first substrate 21, the second substrate 23 is disposed on a side that is of the radio frequency integrated circuit and that is away from the first substrate 21, and the feed transmission line 22 is disposed on the second substrate 23; and the plurality of antennas 10 may be disposed on a side that is of the second substrate 23 and that is away from the radio frequency integrated circuit, and be connected to the radio frequency integrated circuit through the feed transmission line 22. In this embodiment, the plurality of antennas 10 are arranged in an array form, and are integrated on one side of the second substrate 23 through soldering and the like, and a radio frequency integrated circuit chip may be integrated on the other side of the second substrate 23. The second substrate 23 is packaged as a whole by using the antenna-in-package technology (for example, a ball grid array (BGA) package technology may be used). Subsequently, a manufactured package is soldered onto a circuit board (PCB) 25 by using a ball grid array 24, and circuits such as a digital-to-analog conversion circuit and a digital signal processing circuit may further be disposed on the circuit board 25.

In addition, the antenna module 20 may also use an antenna-on-chip technology. FIG. 20 is a diagram of another structure of an antenna module according to an embodiment of this application. As shown in FIG. 20, the antenna module 20 may further include a first substrate 21; the radio frequency integrated circuit may be disposed on a side of the first substrate 21, and the feed transmission line 22 is disposed on the radio frequency integrated circuit; and the plurality of antennas 10 may be disposed on a side that is of the radio frequency integrated circuit and that is away from the first substrate 21, and be connected to the radio frequency integrated circuit through the feed transmission line 22. In this embodiment, the plurality of antennas 10 are directly integrated, in an array form, on an outer surface of a radio frequency integrated circuit chip obtained through plastic packaging, and the antenna 10 and the radio frequency integrated circuit chip are used as a component as a whole, where the component may be soldered onto a circuit board.

In addition, the antenna module 20 may alternatively use an antenna-on-board technology. FIG. 21 is a diagram of another structure of an antenna module according to an embodiment of this application. As shown in FIG. 21, the antenna module 20 may further include a circuit board; the feed transmission line 22 is disposed on the circuit board 25, and the radio frequency integrated circuit may be disposed on a side of the circuit board 25; and the plurality of antennas 10 may be disposed on a side that is of the circuit board 25 and that is away from the radio frequency integrated circuit, and be connected to the radio frequency integrated circuit through the feed transmission line 22. In this embodiment, the plurality of antennas 10, a radio frequency integrated circuit chip, a digital-to-analog conversion circuit, and a digital signal processing circuit are all integrated on the same circuit board 25.

Based on a same design concept, this application further provides an electronic device. The electronic device includes the antenna module 20 in the foregoing embodiments. In the foregoing electronic device, the antenna module 20 may have a stopband outside a passband, so that out-of-band spur of the electronic device can be suppressed. A specific type of the electronic device is not limited. In some embodiments, the electronic device may be a communication device, for example, a base station or a communication terminal. In some other embodiments, the electronic device may alternatively be radar.

It is clear that a person skilled in the art can make various modifications and variations to this application without departing from the protection scope of this application. This application is intended to cover these modifications and variations of this application provided that these modifications and variations fall within the scope of the claims of this application and their equivalent technologies.

1. An antenna, comprising:
a first dielectric layer, a second dielectric layer, and a third dielectric layer, wherein the third dielectric layer is disposed at a layer different from that of the second dielectric layer, wherein:
a first radiating element is disposed at the first dielectric layer;
the second dielectric layer and the third dielectric layer are located on a same side of the first dielectric layer;
a feed line is disposed at the second dielectric layer,
the feed line is configured to feed the first radiating element;
a split resonance unit is disposed at the third dielectric layer, and
the split resonance unit is in signal connection with the feed line.

2. The antenna according to claim 1, wherein along a first direction perpendicular to the third dielectric layer, the feed line has a first projection at the third dielectric layer, and the first projection at least partially overlaps the split resonance unit.

3. The antenna according to claim 2, wherein the first projection and the split resonance unit have a first intersection point.

4. The antenna according to claim 3, wherein the split resonance unit is a symmetric figure, and a split of the split resonance unit is not symmetric with respect to the first projection.

5. The antenna according to claim 2, wherein the first projection and the split resonance unit have at least two intersection points;
wherein the at least two intersection points include a second intersection point that is closest to a split of the split resonance unit along a circumference of the split resonance unit; and
wherein, along the circumference of the split resonance unit, there is a first distance between the second intersection point and one end of the split, there is a second distance between the second intersection point and an other end of the split, and the first distance is less than the second distance.

6. The antenna according to claim 1, wherein along a first direction perpendicular to the third dielectric layer, the feed line has a first projection at the third dielectric layer, and the first projection does not intersect the split resonance unit; and
the antenna further includes a transmission line, wherein a first end of the transmission line is connected to the feed line, and a second end of the transmission line is connected to the split resonance unit.

7. The antenna according to claim 6, wherein the transmission line has a second projection at the third dielectric layer along the first direction, and a length L1 of the second projection satisfies (2n+1)λ/4−λ/8≤L1≤(2n+1)λ/4+λ/8, wherein n is a natural number, and λ is a dielectric wavelength of the third dielectric layer.

8. The antenna according to claim 2, wherein the antenna further comprises a fourth dielectric layer located between the first dielectric layer and the second dielectric layer, a slot is provided at the fourth dielectric layer, and the feed line feeds the first radiating element through the slot.

9. The antenna according to claim 2, wherein the antenna further comprises a probe component, one end of the probe component is connected to the feed line, and an other end is connected to the first radiating element.

10. The antenna according to claim 1, wherein the split resonance unit includes at least one split resonator, a circumference of each split resonator is an integer multiple of ½ of a dielectric wavelength of the third dielectric layer.

11. The antenna according to claim 10, wherein the split resonance unit includes a first split resonator and a second split resonator, and the first split resonator and the second split resonator are separately in the signal connection with the feed line, wherein, along a first direction perpendicular to the third dielectric layer, the feed line has a first projection at the third dielectric layer, and wherein the first split resonator and the second split resonator are symmetrically disposed with respect to the first projection, or the first split resonator and the second split resonator are disposed at an interval along a direction of the feed line; or
wherein the split resonance unit includes the first split resonator and the second split resonator that are spaced, the first split resonator and the second split resonator are symmetrically disposed with respect to a centrosymmetric line, a split of the first split resonator and a split of the second split resonator are oriented in a same direction, the first split resonator is disposed close to the feed line, and is in the signal connection with the feed line, and the second split resonator is coupled to the first split resonator.

12. The antenna according to claim 10, wherein the split resonator is a triangular split resonator, a circular split resonator, a rhombic split resonator, a rectangular split resonator, or an 8-shaped split resonator.

13. An antenna module, comprising:
a plurality of antennas, wherein each antenna includes a first dielectric layer, a second dielectric layer, and a third dielectric layer, wherein the third dielectric layer is disposed at a layer different from that of the second dielectric layer, wherein:
a first radiating element is disposed at the first dielectric layer;
the second dielectric layer and the third dielectric layer are located on a same side of the first dielectric layer;
a feed line is disposed at the second dielectric layer, and the feed line is configured to feed the first radiating element; and
a split resonance unit is disposed at the third dielectric layer, and the split resonance unit is in signal connection with the feed line.

14. The antenna module according to claim 13, wherein along a first direction perpendicular to the third dielectric layer, the feed line has a first projection at the third dielectric layer, and the first projection at least partially overlaps the split resonance unit.

15. The antenna module according to claim 13, wherein along a first direction perpendicular to the third dielectric layer, the feed line has a first projection at the third dielectric layer, and the first projection does not intersect the split resonance unit; and
wherein each antenna further comprises a transmission line, wherein a first end of the transmission line is connected to the feed line, and a second end of the transmission line is connected to the split resonance unit.

16. The antenna module according to claim 13, further comprising:
a first substrate, a second substrate, a feed transmission line, and a radio frequency integrated circuit, wherein the radio frequency integrated circuit is disposed on a side of the first substrate, the second substrate is disposed on a side that is of the radio frequency integrated circuit and that is away from the first substrate, and the feed transmission line is disposed on the second substrate, and the plurality of antennas are disposed on a side that is of the second substrate and that is away from the radio frequency integrated circuit, and are connected to the radio frequency integrated circuit through the feed transmission line; or,
the first substrate, the feed transmission line, and the radio frequency integrated circuit, wherein the radio frequency integrated circuit is disposed on a side of the first substrate, and the feed transmission line is disposed on the radio frequency integrated circuit, and the plurality of antennas are disposed on a side that is of the radio frequency integrated circuit and that is away from the first substrate, and are connected to the radio frequency integrated circuit through the feed transmission line; or,
a circuit board, the feed transmission line, and the radio frequency integrated circuit, wherein the feed transmission line is disposed on the circuit board, and the radio frequency integrated circuit is disposed on a side of the circuit board,
and the plurality of antennas are disposed on a side that is of the circuit board and that is away from the radio frequency integrated circuit, and are connected to the radio frequency integrated circuit through the feed transmission line.

17. An electronic device, comprising:
an antenna module, wherein the antenna module includes a plurality of antennas, each antenna includes a first dielectric layer, a second dielectric layer, and a third dielectric layer, wherein the third dielectric layer is disposed at a layer different from that of the second dielectric layer,
wherein a first radiating element is disposed at the first dielectric layer, the second dielectric layer and the third dielectric layer are located on a same side of the first dielectric layer, a feed line is disposed at the second dielectric layer, and the feed line is configured to feed the first radiating element, and a split resonance unit is disposed at the third dielectric layer, and the split resonance unit is in signal connection with the feed line.

18. The electronic device according to claim 17, wherein along a first direction perpendicular to the third dielectric layer, the feed line has a first projection at the third dielectric layer, and the first projection at least partially overlaps the split resonance unit.

19. The electronic device according to claim 17, wherein along a first direction perpendicular to the third dielectric layer, the feed line has a first projection at the third dielectric layer, and the first projection does not intersect the split resonance unit; and
wherein each antenna further include a transmission line, wherein a first end of the transmission line is connected to the feed line, and a second end of the transmission line is connected to the split resonance unit.

20. The electronic device according to claim 17, wherein the antenna module further comprises a first substrate, a second substrate, a feed transmission line, and a radio frequency integrated circuit, wherein the radio frequency integrated circuit is disposed on a side of the first substrate, the second substrate is disposed on a side that is of the radio frequency integrated circuit and that is away from the first substrate, and the feed transmission line is disposed on the second substrate, and the plurality of antennas are disposed on a side that is of the second substrate and that is away from the radio frequency integrated circuit, and are connected to the radio frequency integrated circuit through the feed transmission line; or,
wherein the antenna module further comprises the first substrate, the feed transmission line, and the radio frequency integrated circuit, wherein the radio frequency integrated circuit is disposed on a side of the first substrate, and the feed transmission line is disposed on the radio frequency integrated circuit, and the plurality of antennas are disposed on a side that is of the radio frequency integrated circuit and that is away from the first substrate, and are connected to the radio frequency integrated circuit through the feed transmission line; or,
wherein the antenna module further comprises a circuit board, the feed transmission line, and the radio frequency integrated circuit, wherein the feed transmission line is disposed on the circuit board, and the radio frequency integrated circuit is disposed on a side of the circuit board, and the plurality of antennas are disposed on a side that is of the circuit board and that is away from the radio frequency integrated circuit, and are connected to the radio frequency integrated circuit through the feed transmission line.
